(19) United States
(12) Patent Application Publication
(10) Pub. No.: US 2011/0116529 A1
(43) Pub. Date: May 19, 2011

(54) LABEL FOR INDICATING THE HISTORY OF HIGH-TEMPERTURE EXPOSURE

(76) Inventors: Won Young SONG, Seo-gu (KR); Deukyou YOON, Bupyeong-gu (KR)

(21) Appl. No.: 13/011,289

(22) Filed: Jan. 21, 2011

Related U.S. Application Data
(63) Continuation of application No. PCT/KR2009/003704, filed on Jul. 7, 2009.

(30) Foreign Application Priority Data
Jul. 21, 2008 (KR) 10-2008-0070818

(51) Int. Cl. G01K 3/00

(52) U.S. Cl. 374/106; 374/E03.001

(57) ABSTRACT

A label for indicating a history of high-temperature exposure includes an internal substance and an external substance surrounding the internal substance. The internal substance and the external substance may be separated into respective frozen solid bodies at low temperatures, the internal and external substances having colors that are different from each other, and at least one of the internal substance and the external substance may convert to a liquid phase and the internal and external substances may be naturally mixed when the substances are exposed to high temperatures higher than the low temperatures for a predetermined amount time, and indicate the history of high temperature exposure without being restored to the initial forms of their frozen solid bodies even when refrozen or re-cold stored.

### CROSS-REFERENCE TO RELATED APPLICATION

This application is a continuation of pending International Application No. PCT/KR2009/003704, entitled “Label for Indicating the History of High-Temperature Exposure,” which was filed on Jul. 7, 2009, the entire contents of which are hereby incorporated by reference for all purposes.

### BACKGROUND

1. Field

Embodiments relate to a label for indicating the history of high-temperature exposure.

2. Description of Related Art

Low-temperature distribution may be required to allow temperature-sensitive products to be conveyed across a long distance. Absent proper temperature controls, it may be difficult to maintain an appropriate temperature for the temperature-sensitive products. In the case of exposure to undue temperature extremes, the qualities of the products are apt to deteriorated.

### SUMMARY

An embodiment is directed to a label for indicating a history of high-temperature exposure, including an internal substance and an external substance surrounding the internal substance. The internal substance and the external substance may be separated into respective frozen solid bodies at low temperatures, the internal and external substances having colors that are different from each other, and at least one of the internal substance and the external substance may convert to a liquid phase and the internal and external substances are naturally mixed when the substances are exposed to high temperatures higher than the low temperatures for a predetermined amount time, and indicate the history of high temperature exposure without being restored to the initial forms of their frozen solid bodies even when refrozen or re-cold stored.

The label may further include a transparent sealing material that seals the external substance.

The sealing material may be attached to frozen or cold-storage products.

The internal substance may have at least one shape selected from spherical, cylindrical, conical, prismatic, pyramidal, letter, and ellipsoidal shapes.

A plurality of internal substances may be used in the label, the internal substances having dissolution temperatures and colors that are different from each other.

The internal substance may include a material that dissolves in the liquid phase of the external substance, and exhibits different degrees of dissolution in the external substance according to the time of exposure to the high temperatures

### BRIEF DESCRIPTION OF THE DRAWINGS

The above and other features and advantages will become more apparent to those of skill in the art by describing in detail example embodiments with reference to the attached drawings, in which:

FIG. 1 illustrates a schematic structure of a label for indicating the history of high-temperature exposure according to an embodiment;

FIG. 2 illustrates an example of a label according to an embodiment as attached to an external part of a frozen or cold-stored product; and

FIG. 3 illustrate example changes in form of the “internal substance” when a label according to an embodiment has been exposed to high temperatures for a predetermined time or longer and is refrozen or cold-stored again.

### DESCRIPTION OF THE NUMBERS IN THE DRAWINGS

11: external substance;
12: internal substance;
13: coating of sealing material;
21: label;
22: product package of the frozen or cold-storage goods;
31: label, in state of the normal goods;
32: label, in state of high temperature exposure of a short time; and
33: label, in state of high temperature exposure of a long time.

### DETAILED DESCRIPTION

Korean Patent Application No. 10-2008-0070818, filed on Jul. 21, 2008, in the Korean Intellectual Property Office, and entitled: “Label for Indicating the History of High-Temperature Exposure,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Embodiments disclosed herein relate to a label for indicating the history of high-temperature exposure of a product. The label according to embodiments may be used to easily and cheaply check the temperature change history during the distribution or use of the product.

Embodiments may provide a way to enable end customers to easily check the possibility of quality deterioration of products that may be deteriorated when there is a history of being exposed for a long time to a high-temperature environment, i.e., higher than a predetermined temperature, during the process of the distribution and use of the products.

Recently, advances in low-temperature distribution technology have enabled consumers to easily obtain a variety of products produced at a long distance. However, as the distribution distance and time gets farther and longer, it may become more and more difficult to maintain an appropriate temperature for products distributed at low temperatures. In the case of exposure to temperatures that are unsuitable for the products, the qualities of the products are apt to deteriorated. Moreover, subsequent cold-storage of the products, e.g., refreezing or re-cold storing, may lead to a problem in that end customers may not be aware of the possibility of quality changes, e.g., deterioration, of the products.

Although producers and distributors may attempt to check for and prevent temperature changes by way of e.g., temperature tracking in workspaces, temperature tracking of cargo boxes of low-temperature distribution vehicles, temperature tracking of sellers' storage warehouses, etc., in order to prevent the quality changes of low-temperature products during the distribution process, problems may continue to exist. For example, high temperature variations according to the loading position and the position of a temperature detection sensor may keep the temperature change of each product from being recognized. Furthermore, it may not be possible to check the temperature change resulting from a long period of exposure to external environments when the loading and unloading work is performed during each distribution step. Furthermore, a temperature tracking mode, by which the distributors alone can check the temperature changes of products, may not allow end customers to check the temperature changes for themselves.

In an example embodiment, the label may include two or more forms of substances that combine to produce an irreversible, visual change in the label upon exposure to predetermined temperature conditions, e.g., too high a temperature or too high a temperature for too long a period for the particular product to which the label is affixed. In an implementation, double forms may be manufactured such that an internal substance with a predetermined form is visibly surrounded by an external substance. The label may be cold-stored at a temperature appropriate for the subject product. Then label in a sealed form may be attached to the external part of the subject product.

If a low-temperature distribution product with a label according to an embodiment for indicating the history of high-temperature exposure is exposed to an environment at temperatures higher than an appropriate temperature for a long time, the external substance may first be changed into a liquid phase, the internal substance may then be changed into a liquid phase, and then the two substances in the liquid phase may naturally mix with each other. Accordingly, even when the temperature of the environment is subsequently restored to a temperature lower than the appropriate preservation temperature, the initial form of the internal substance may be maintained in an altered state, or a color may appear or disappear. For example, the color of the internal substance may be mixed with the color of the external substance. Such irreversible visual changes may thus enable customers to easily check the temperature change history with the naked eye and prevent damage that might be caused by use of the product whose quality has been deteriorated

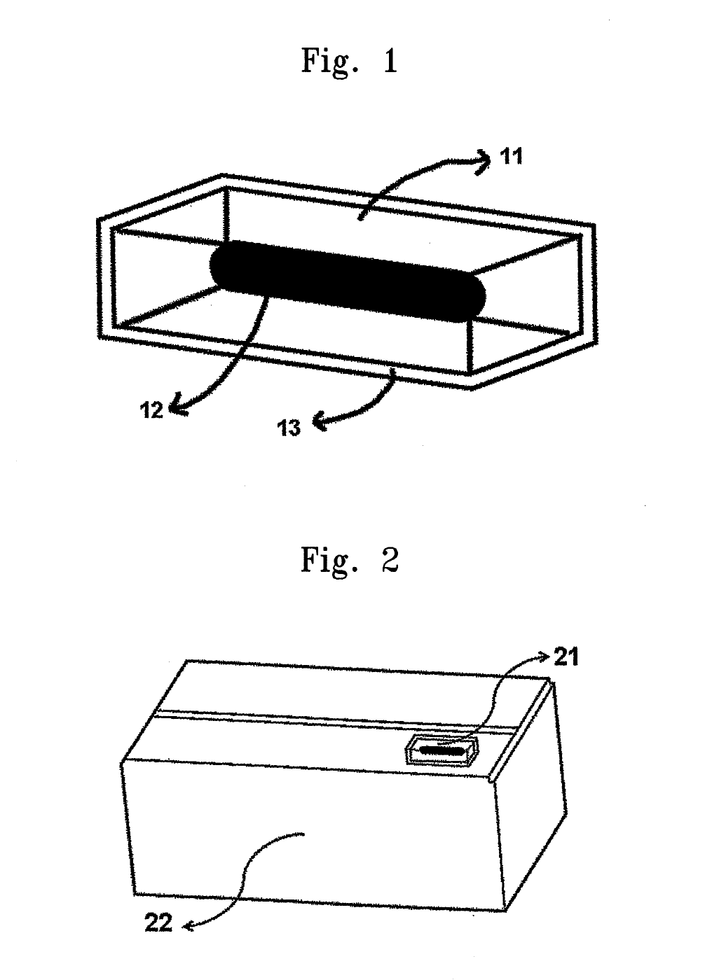

Referring to FIG. 1, a double frozen substance may be configured by putting the internal substance (12) into a mold having a predetermined form, freezing the assembly, placing it in the external substance (11), and cold-storing the whole. The label may be sealed by a transparent synthetic resin, etc. Referring to FIG. 2, a label for indicating the temperature change history may be prepared and attached to an appropriate position of the external part of a package (22) of a frozen or cold-storage product.

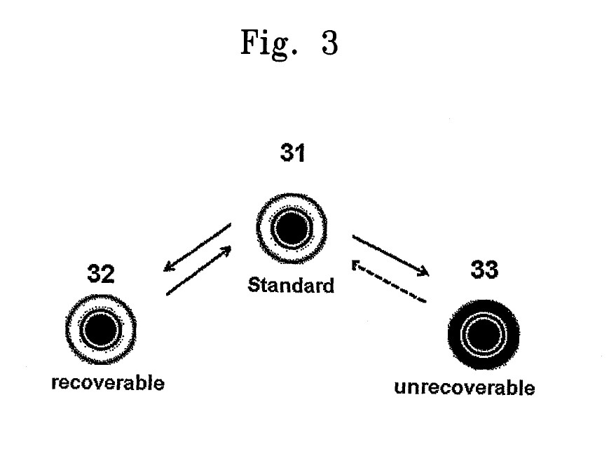

When the corresponding frozen or cold-storage product is exposed to a high-temperature environment higher than the appropriate preservation temperature thereof for a predetermined time or longer, the external substance (11) may first be changed into a liquid phase, the internal substance (12) may then be changed into a liquid phase, and subsequently the two liquids may spontaneously mix. In an implementation, referring to FIG. 3, an initial form (31) of the internal substance (12) including a dye may disappear or a mixed color may appear, as shown by an irreversibly altered label (33) in FIG. 3. Subsequently, even when the temperature of the environment is changed to a level lower than the appropriate temperature through a refreezing process, the initial form of the internal substance (12) is not restored and, thus, customers may easily check whether the corresponding product has been exposed to high temperatures higher than the preservation temperature thereof to determine whether the quality of the product has been deteriorated. Otherwise, if the temperature exposure has not been undue, the label may retain its original appearance, as shown by label (32) in FIG. 3.

If it is necessary to expose a product to high temperatures (higher than the appropriate temperature for the product) for a short time, e.g., for a typical loading and unloading operation of a transport vehicle, then the label according to an embodiment for indicating the history of high-temperature exposure may be configured to prevent the label from being changed. For example, the thickness and/or composition of the external substance (11) may be controlled in order to prevent the label from being changed, and thus the label for indicating the history of high-temperature exposure may be prevented from being changed such that for a short time of exposure, the external substance (11) may be restored to its original state even after the substance is changed. See, e.g., label (32) in FIG. 3.

A frozen or solid substance used in a label according to an embodiment may use, e.g. water. In an implementation, water may be mixed with a freezing point modifier, e.g., solutes such as salts, alcohols, etc., such that the freezing point is changed by the effect of the molarity of the aqueous solution. Accordingly, temperature lowering effects, depending on the range of the preservation temperature of the product and the conditions of high-temperature exposure time and temperature, may be applied using substances which maintain a liquid phase at other appropriate temperatures. In an implementation, a change in coloration may be exhibited when the internal substance (11) and the external substance (12) are mixed, e.g., by including a dye in one or both of the internal and external substances. In another implementation, chemical reagents may be used that exhibit a change in coloration when the internal substance (11) and the external substance (12) are mixed instead of a dye being added into either of them.

In cases where a label according to an embodiment composed of a double-frozen substance is applied to low-temperature distribution food, the distribution of the food, which would be apt to be deteriorated when the product is exposed to high-temperature environments higher than the appropriate temperature for a predetermined time or longer, may be prevented, and thus a system where producers gain reliability from customers and customers safely purchase and consume the corresponding food products may be set up.

Additional details of example embodiments will now be described.

In an embodiment, a label for indicating the history of high-temperature exposure may have a colored or colorless substance formed to have a predetermined shape. The internal substance may be formed to be surrounded by the external substance having a color different form that of the internal substance, or colorless. The solid substances may be cold-stored to manufacture a frozen solid body with a double structure, the frozen solid body being configured for attachment to a subject product. When the subject product is exposed for a long time to a high-temperature environment higher than the appropriate preservation temperature, the external substance and the internal substance may be changed into a liquid phase and naturally mixed, and subsequently are restored to their initial forms of the double solid body, to thereby check the history of high-temperature exposure during the distribution or use of the product even when the product is again cold-stored, e.g., refrozen after being thawed.

The label may be exposed to a high temperature environment, which may change the internal substance and the external substance into a wholly or partially mixed liquid phase exhibiting a visible difference from the label's original state. The label may be configured such that the label is sealed by a transparent material and attached to the external part of a subject product. The sealing material may be configured to prevent the contamination of the subject product by the substances, e.g., even if they melt.

The label may include the internal substance with one or more of various shapes of spherical, cylindrical, conical, prismatic, pyramidal, letter, and ellipsoidal shapes. In an implementation, the shapes may be irreversibly lost upon exposure to high temperature. In an implementation, the label may be configured with a plurality of the internal substances, e.g., two or more internal substances that are different from one another, and the label may be formed with a double-frozen substance to apply individual colors depending on respective dissolution temperatures of the two or more internal substances.

The internal substance and the external substance may each be water based. An aqueous solution using molar lowering effects in consideration of the temperature range of the subject product and the allowable time of high-temperature exposure, or an organic compound that maintains a liquid phase at an appropriate temperature, may be used. The label may be formed with a double-frozen substance using the same.

The internal substance constituting the label for indicating the history of high-temperature exposure may be formed of a substance that is configured to be dissolved in the external substance in a liquid phase. In an implementation, when the label for indicating the history of high-temperature exposure is exposed to high temperatures for a short time and then again cold-stored, the exposure time may be estimated according to the degree of diffusion of the internal substance into the external substance, which is different depending on the exposure time of the label to high temperatures.

As set forth above, embodiments relate to a label for indicating the history of high-temperature exposure of a product. The label may be configured to be attached to product packaging and may be used to enable consumers to easily check whether the quality of the product may have been changed, e.g., in cases where the distribution or use of the product in a high-temperature environment (higher than the proper preservation temperature) significantly affects the quality of the product. The label for indicating the history of high-temperature exposure of a product according may be configured such that a colored or colorless substance (12) (the internal substance) with a predetermined form is visually surrounded by another substance (11) (the external substance), which may have a color different from that of the internal substance or which may be colorless. The resultant structure may be sealed by a transparent substance (13) for preventing leakage. Thus, if frozen or cold-storage goods with the label according to an embodiment for indicating the history of high-temperature exposure of a product are exposed to a high-temperature environment higher than the preservation temperature thereof, the external substance may first be melted into a liquid phase, and subsequently the internal substance may be naturally mixed with the external substance, e.g., with or without melting the internal substance. The mixed form of the internal and external substances may be retained even when the temperature of the environment is changed or restored to a level lower than the preservation temperature, thus enabling consumers to easily check the temperature change history with the naked eye and identifying high temperature exposure even where low temperatures have been restored.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A label for indicating a history of high-temperature exposure, comprising:
an internal substance; and
an external substance surrounding the internal substance, wherein:
the internal substance and the external substance are separated into respective frozen solid bodies at low temperatures, the internal and external substances having colors that are different from each other, and
at least one of the internal substance and the external substance converts to a liquid phase and the internal and external substances are naturally mixed when the substances are exposed to high temperatures higher than the low temperatures for a predetermined amount time, and indicate the history of high temperature exposure without being restored to the initial forms of their frozen solid bodies even when refrozen or re-cold stored.

2. The label as claimed in claim 1, further comprising a transparent sealing material that seals the external substance.

3. The label as claimed in claim 2, wherein the sealing material is attached to frozen or cold-storage products.

4. The label as claimed in claim 1, wherein the internal substance has at least one shape selected from spherical, cylindrical, conical, prismatic, pyramidal, letter, and ellipsoidal shapes.

5. The label as claimed in claim 4, wherein a plurality of internal substances are used in the label, the internal substances having dissolution temperatures and colors that are different from each other.

6. The label as claimed in claim 1, wherein the internal substance includes a material that dissolves in the liquid phase of the external substance, and exhibits different degrees of dissolution in the external substance according to the time of exposure to the high temperatures.
